(19) United States
(12) Patent Application Publication
(10) Pub. No.: US 2003/0034895 A1
(43) Pub. Date: Feb. 20, 2003

(54) Animal drinking apparatus with low level sensing device

(76) Inventor: Ronald S. Reich, Basking Ridge, NJ (US)

Correspondence Address: Mr. Walter J. Tencza Jr., Suite 3, 10 Station Place, Metuchen, NJ, 08840, US

(21) Appl. No.: 09/929,619

(22) Filed: Aug. 15, 2001

(51) Int. Cl. G08B 21/00

(52) U.S. Cl. 340/618; 340/573.3; 340/539

(57) ABSTRACT

An animal drinking apparatus and method which automatically alerts an animal caretaker to low liquid level conditions in a fluid or liquid vessel is disclosed. A standard type of animal drinking vessel can be fitted with a sensing device. A receiving device and one or both of an audible device and a visual device can provide one or more alert signals when the sensing device indicates that a low level fluid condition has occurred in the drinking vessel. The sensing device and the receiving device may be separable for remote operation and a low level transmission signal may be sent via wire, radio frequency, infrared frequency, fiber optics, or in any known manner.

### FIELD OF THE INVENTION

This invention relates to improved methods and apparatus for supplying drinking fluids to animals

### BACKGROUND OF THE INVENTION

Typically in the prior art animals are supplied with drinking fluids when a caretaker of the animals notices that the animals need drinking fluids. However, this is not efficient and leads to unnecessary checking of fluid levels in drinking vessels and failure to provide fluids when an animal requires them.

### SUMMARY OF THE INVENTION

The present invention in one or more embodiments provides an animal drinking apparatus and method which automatically alerts an animal caretaker to low liquid level conditions in a fluid or liquid vessel. A standard type of animal drinking vessel can be fitted with a sensing device. A receiving device and one or both of an audible device and a visual device can provide one or more alert signals when the sensing device indicates that a low level fluid condition has occurred in the drinking vessel. The sensing device and the receiving device may be separable for remote operation and a low level transmission signal may be sent via wire, radio frequency, infrared frequency, fiber optics, or in any known manner.

The present invention in one or more embodiments provides an apparatus comprising a sensing device and a warning device The sensing device provides a low level detection signal when the level of liquid in a liquid vessel has dropped below a lower limit. The warning device provides an alert signal when the sensing device produces a low level detection signal. The alert signal may be comprised of either an audible alert signal or a visual alert signal or both.

The apparatus may be comprised of the liquid vessel, and the sensing device may be fixed to the liquid vessel. The apparatus may be further comprised of a transmitting device and a receiving device. The transmitting device may receive the low level detection signal from the sensing device and may provide a low level transmission signal to the receiving device. The receiving device may receive the low level transmission signal and in response to the low level transmission signal. the receiving device may cause the warning device to provide an alert signal.

The transmitting device may transmit the low level transmission signal to the receiving device in a wireless or hard wired manner. The low level transmission signal may have a frequency in the radio frequency range or in the infrared range.

The present invention in one or more embodiments also discloses a method. The method comprises placing a first quantity of liquid into a liquid vessel and allowing an animal to drink the first quantity of liquid in the liquid vessel. The method further comprises waiting until a warning device produces an alert signal indicating that the amount of liquid in the liquid vessel has become less than a lower limit. The warning device may provide the alert signal when a sensing device produces a low level detection signal. The method further comprises placing a second quantity of liquid into the liquid vessel after an alert signal has been produced and allowing the animal to drink the second quantity of liquid in the liquid vessel.

The method may also include fixing the sensing device to the drinking vessel. The method may also include transmitting a low level transmission signal in response to the low level detection signal, receiving the low level transmission signal, and producing the alert signal in response to the low level transmission signal.

### BRIEF DESCRIPTION OF THE DRAWINGS

FIG. 1 shows a front view of an apparatus, including a liquid vessel and a sensing device for indicating when there is a low amount of liquid in the liquid vessel and a depiction of an animal;

FIG. 2 shows a block diagram of various devices for use in the apparatus of FIG. 1, and

FIG. 3 shows a flow chart of a method in accordance with an embodiment of the present invention.

### DETAILED DESCRIPTION OF THE DRAWINGS

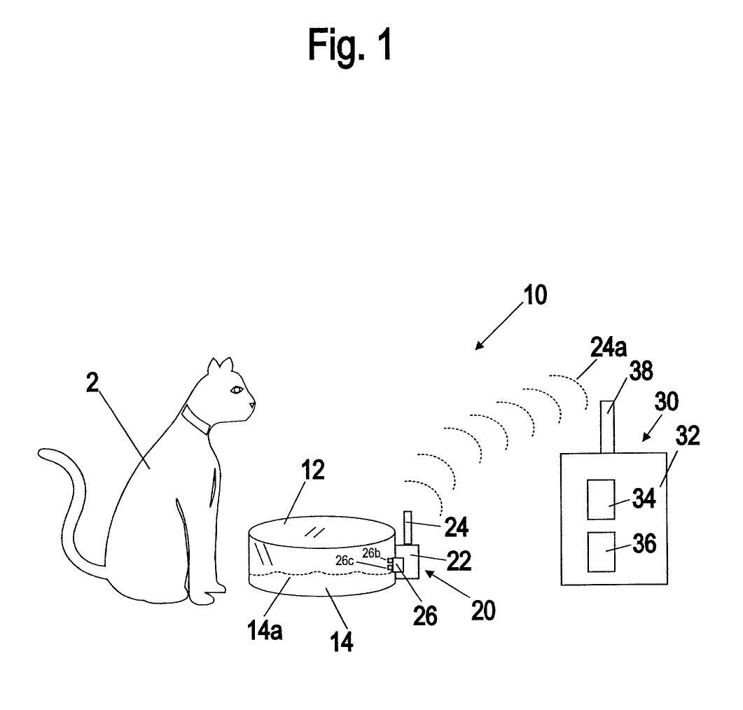

FIG. 1 shows a front view of an apparatus 10, including a liquid vessel 12 and a sensing device 26 for indicating when there is a low amount of liquid in the liquid vessel 12 and a depiction of an animal 2 The animal, in this case is a cat. The apparatus 10 also includes transmitting device 20 which includes device 22 and antenna 24, and receiving device 30 which includes device 32 and antenna 38, and audio device 34 and visual device 36. FIG. 1 also shows a level 14a of liquid 14, said level being shown as dashed curved lines. The sensing device 26 may be of a conductivity type and may include an anode 26b and a cathode 26c which can be exposed to the liquid in the liquid vessel 12. If the liquid is at a level so that the liquid touches both the cathode and the anode and allows a circuit to be completed between the cathode 26c and the anode 26b, current flows from the anode 26b through the liquid and to the cathode 26c and in that case no low liquid level detection signal is produced. However, if the liquid is at a level, such as in FIG. 1 where there is no liquid between the cathode 26c and the anode 26b to form a circuit, then a low liquid level detection signal is produced by the sensing device 26.

The sensing device 26 could be comprised of other known devices, instead of an anode and cathode combination, such as a float, which when the liquid goes below a certain level causes a low liquid level detection signal to be produced. The sensing device 26 may be comprised of and employ a light beam, an audio signal, an electromagnetic signal, a physical liquid signal, or any other type of sensing mechanism to determine if there is a low level of liquid.

FIG. 1 also shows electromagnetic waves or wireless signals 24a being transmitted from antenna 24 and from transmitting device 20 to antenna 38 and receiving device 30.

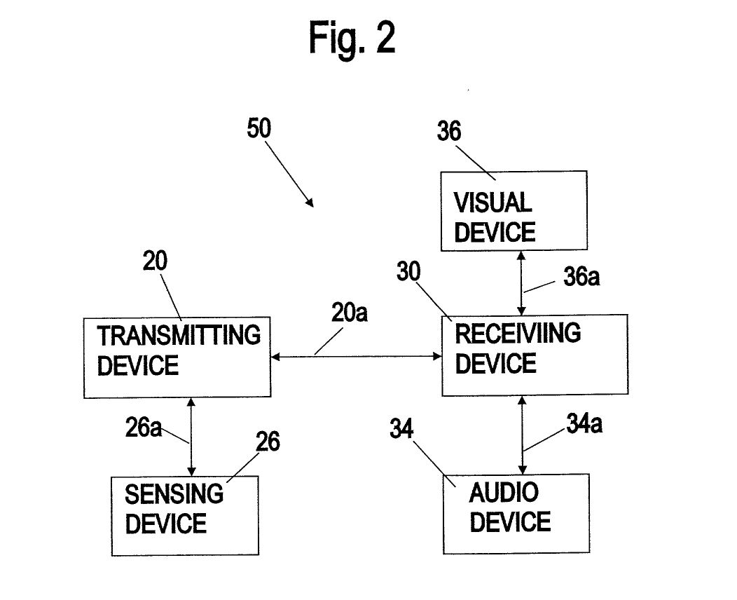

FIG. 2 shows a block diagram 50 of various devices for use in the apparatus 10 of FIG. 1. The block diagram 50 is comprised of transmitting device 20, sensing device 26, visual device 36, receiving device 30, and audio device 34. The transmitting device 20 is connected by a communication link with the sensing device 26 by bus 26a. All communications links in this application may be by hardwiring, wireless means, software connections, optical connections, electromagnetic connections or any other known manner of communication link The transmitting device 20 is also connected by a communications link 20a to receiving device 30. The receiving device 30 is connected to the visual device 36 by a communications link 36a. The receiving device 30 is connected to the audio device 34 by a communications link 34a.

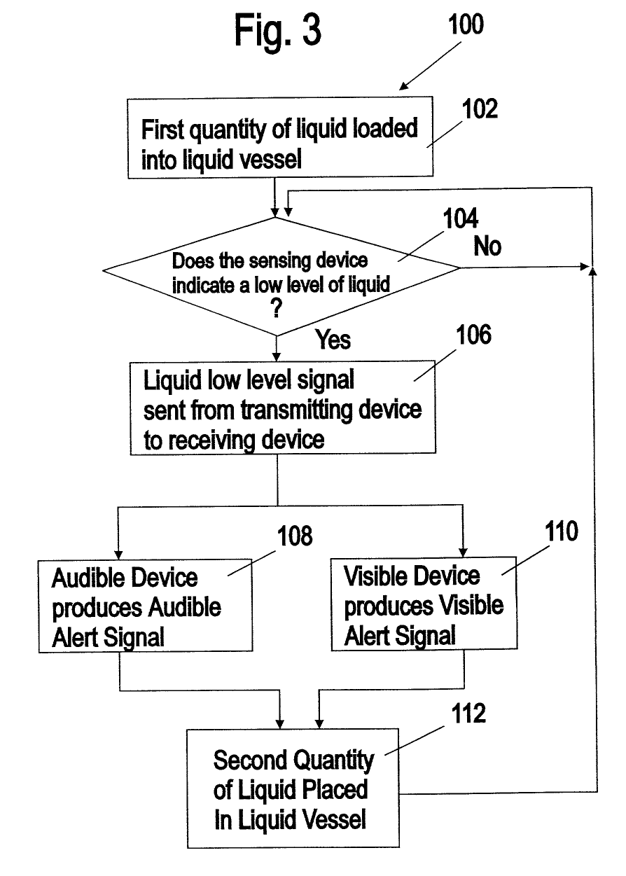

FIG. 3 shows a flow chart 100 of a method in accordance with an embodiment of the present invention. At step 102, a first quantity of liquid is loaded into a liquid vessel, such as liquid vessel 12 shown in FIG. 1 At step 104 the sensing device 26 determines whether there is a sufficiently low level in the liquid vessel 12. If all of the liquid 14 is below the sensing device 26, i.e. in one example low enough so that current cannot flow from an anode through the liquid 14 to the cathode, the sensing device detects a low level of liquid. The sensing device 26 may use a light beam, an audio signal, an electromagnetic signal, a physical liquid signal, or any other type of sensing mechanism to determine if there is a low level of liquid

If there is a low level of liquid as in FIG. 1, then the sensing device 26 supplies to device 22 a low liquid level detection signal such as an electronic, electromagnetic, or optical indication that a low level has been detected The device 22 may be comprised of electronics which translate the low liquid level detection signal from sensing device 26 and cause a low liquid level transmission signal to be transmitted out from antenna 24 as electromagnetic waves 24a at step 106 of FIG. 3. The low liquid level transmission signal may instead be transmitted in a hard wired manner, in an optical manner, in a software manner, or in any known manner. If a low level is not detected by the sensing device 26, the sensing device would simply remain active and in essence continually execute step 104 until a low level of liquid is detected.

The low level transmission signal is received by antenna 38 of receiving device 30. Antenna 38 supplies the low level transmission signal to device 32 which may include electronics for translating the low level transmission signal and for causing the visual device 36 and the audio device 34 to be activated at steps 108 and 110 of FIG. 3. If a low level is indicated, as in FIG. 1, the device 32 may activate both the visual device 36 causing a visual alert signal to be produced and the audio device 36 causing an audible alert signal to be produced. Alternatively, one of the two devices 34 and 36 may be activated for a low level condition. Either the visual device 36 or the audio device 34 or both of the devices 34 and 36 may be called a warning device in accordance with embodiments of the present invention. Either the audible alert signal or the visual alert signal or the combination of the audible alert signal and the visual alert signal may be called an alert signal.

A human operator, or a machine operator, may respond to the audible alert signal and the visual alert signal by placing a second quantity of liquid in the liquid vessel 12 at step 112 so that the sensing device 26 no longer detects a low level condition.

The sensing device 26 may be fixed with respect to the bowl 12 so that a low condition can be consistently detected, i e a low condition can be detected for about one milliliter of liquid, for example

I claim:

1. An animal drinking apparatus comprising:
a sensing device;
a warning device;
wherein the sensing device provides a low liquid level detection signal when the level of liquid in a liquid vessel for animal drinking has dropped below a lower limit;
and wherein the warning device provides an alert signal when the sensing device produces a low liquid level detection signal

2. The apparatus of claim 1
wherein the alert signal is comprised of an audible alert signal.

3. The apparatus of claim 1
wherein the alert signal is comprised of a visual alert signal.

4. The apparatus of claim 2
wherein the alert signal is comprised of a visual alert signal.

5. The apparatus of claim 1
wherein the apparatus is comprised of the liquid vessel and the sensing device is fixed to the liquid vessel.

6. The apparatus of claim 1 further comprising
a transmitting device; and
a receiving device;
wherein the transmitting device receives the low liquid level detection signal from the sensing device and provides a low liquid level transmission signal to the receiving device;
and wherein the receiving device receives the low liquid level transmission signal and in response to the low liquid level transmission signal, the receiving device causes the warning device to provide an alert signal

7. The apparatus of claim 6 wherein
the transmitting device transmits the low liquid level transmission signal to the receiving device in a wireless manner.

8. The apparatus of claim 6 wherein
the transmitting device transmits the low liquid level transmission signal to the receiving device in a hardwired manner

9. The apparatus of claim 6 wherein
the low liquid level transmission signal has a frequency in the radio frequency range

10. The apparatus of claim 6 wherein
the low liquid level transmission signal has a frequency in the infrared frequency range.

11. A method comprising the steps of
placing a first quantity of liquid into a liquid vessel,
allowing an animal to drink the first quantity of liquid in the liquid vessel;
waiting until a warning device produces an alert signal indicating that the amount of liquid in the liquid vessel has become less than a lower limit, wherein the warning device provides the alert signal when a sensing device produces a low liquid level detection signal; and
placing a second quantity of liquid into the liquid vessel after an alert signal has been produced; and
and allowing the animal to drink the second quantity of liquid in the liquid vessel.

12. The method of claim 11 further comprising the steps of
fixing the sensing device to the drinking vessel

13. The method of claim 11 wherein
the alert signal is comprised of a visual signal.

14. The method of claim 11 wherein
the alert signal is comprised of an audible signal.

15. The method of claim 13 wherein
the alert signal is comprised of an audible signal

16. The method of claim 11 further comprising the steps of
transmitting a low liquid level transmission signal in response to the low level detection signal;
receiving the low liquid level transmission signal;
and producing the alert signal in response to the low liquid level transmission signal.

17. The method of claim 16 wherein
the low liquid level transmission signal is transmitted in a wireless manner.

18. The method of claim 16 wherein
the low liquid level transmission signal is transmitted in a hard wired manner.
